(19) United States
(12) Patent Application Publication
(10) Pub. No.: US 2022/0058317 A1
(43) Pub. Date: Feb. 24, 2022

(54) SMART PROCESS CONTROL SYSTEM FOR CONTINUOUS TREATMENT OF FELTS

(71) Applicant: RICARDO REIS DE CARVALHO, Valinhos - SP (BR)

(72) Inventors: RICARDO REIS DE CARVALHO, Valinhos - SP (BR); RICARDO DE LIMA BARRETO, Valinhos - SP (BR)

(21) Appl. No.: 17/210,537

(22) Filed: Mar. 24, 2021

(30) Foreign Application Priority Data
Aug. 23, 2020 (BR) BR 102020017229-8

(51) Int. Cl. G06F 30/27; G06N 20/00; G06N 5/02; G06Q 50/04

(52) U.S. Cl. CPC G06F 30/27; G06N 20/00; G06F 2113/12; G06Q 50/04; G06N 5/022

(57) ABSTRACT

This Invention Patent application refers to a smart process control system for continuous treatment of paper and cellulose machine clothing and parts, in which three machine learning methods are covered, comprising learning and predictive algorithms especially developed for constant evaluation of the knowledge base, aiming at operational optimizations, online monitoring of relevant parameters through use of IoT (Internet of Things) for detection of faults and opportunities, in addition to modeling of ideal operation conditions through directed statistical simulations. The synchronism of this artificial intelligence cycle enables automatic decision making on the best chemical and mechanical strategy for application, aiming at the best possible performance.

### FIELD OF APPLICATION

This Invention Patent application refers to a smart process control system for continuous treatment of paper and cellulose machine clothing and parts. Three machine learning methods are covered, which encompass learning and predictive algorithms especially developed for constant evaluation of the knowledge base, aiming at operational optimizations, online monitoring of relevant parameters through use of IoT (Internet of Things) for detection of faults and opportunities, in addition to modeling of ideal operation conditions through directed statistical simulations. The synchronism of this artificial intelligence cycle enables automatic decision making on the best chemical and mechanical strategy for application, aiming at the best possible performance.

### PREAMBLE

This Invention Patent application comprises a smart process control system for continuous treatment of paper and cellulose machine clothing and parts. This system performs cleaning of contaminant deposits included in felts and screens through application of a heated and pressurized cleaning solution, with increased detergent power. It should be noted that the occurrence of organic and inorganic deposits affects drainability and, consequently, the service life of felts and screens, resulting in productivity losses, deterioration of product quality and increase in production costs.

The formation of deposits in the wet part of paper and cellulose machines might be considered a “non-linear process”, governed by complex mechanisms of agglomeration of sticky materials (Rojas, O. J. et al., 2006), specifically called “pitch” and “stickies” in the paper production industry, which may be glued to the suction boxes, shaping screens, felts and press rolls, even reaching the drying section.

The challenging lies in that the contaminants feature a complex chemical composition, including species that are distributed in a soft balance between dissolved and suspended phases (colloid state), before clustering up and forming larger deposits (above 5 μm), depending on the water medium conditions which are affected by chemical and mechanical parameters, such as pH, temperature, pressure, turbidity, conductivity, hardness, among others. In other words, for more realistic predictions, a mathematical and empirical modeling of the deposition mechanism through specific algorithms.

At a first level, regardless of the industry segment and the desired application, the process parameters are categorized according to the type of influence to be imposed over time, of the means in which said parameters are inserted and use conditions. However, for development of smart process controls, these were strategically divided into “observable” or “control” parameters, which are those that allow modulation or not. Additionally, control parameters may be distributed internally or externally, depending on self-sufficiency for changes, more precisely dependent or not from external authorization, in other words, out of range of control parameters.

An example of an observable parameter in the paper production process would be the width of the paper machine that cannot be adjusted, unless investment is made on a new machine. As an external control parameter, the degree of closure of the water circuit that depends on evaluation of environmental criteria by the management team may be mentioned. In turn, a standard internal control parameter would be the dosage of the continuous application chemical. The key is that this invention Patent must comprise sensory mechanisms that enable direct or indirect monitoring of some of these control parameters, providing the application of the concept of Internet of Things (IoT).

IoT is one of the eight technological clusters identified as impacting to the paper and cellulose production within the context of the 4.0 industry, which aims at the integration of virtual and physical systems in production processes (de Paula, G. M. et al., 2018). Therefore, it has become an important precondition for installation of any smart process control systems, allowing for data collection, real-time information analysis and generation, key for quick decision making regarding application processes.

This way, our view of a smart process control system for continuous treatment of clothing must encompass specific methods, with respective logical procedures, governed by numerous algorithm types (learning and predictive algorithms, in this case) which rely on real-time input of the most relevant control parameters, automatic fault detection mechanisms and opportunities in the operation routine, systematic querying of a knowledge base enriched with historical data, analysis of trends for constant optimization of process conditions, avoiding or extending the need for possible corrective actions, in addition to the outline of ideal “resolution” conditions through mathematical models based on conditioned probabilities, reaching new performance levels, whenever possible. This is the “virtuous cycle” behind the success of artificial intelligence applied to the 4.0 industry.

### STATE OF THE ART

This Invention Patent application assumes the knowledge acquired in field presented above, highlighting the most relevant technological advances in employing artificial intelligence for control of industrial processes, particularly online monitoring, and automatic fault detection methods, in addition to use of various machine learning algorithms in different industrial applications. There is no questioning that the basis for any initiative in this area goes beyond deep understanding of the root cause for the issues that may affect both productivity and the quality of industrial products. Human operational errors, equipment runnability conditions and the characteristics of raw materials and other additives used in production processes are among the main reasons for deviations of standard conditions, herein classified as “faults”, leading to irreparable economic losses.

In this sense, literature has more recently provided methods that facilitate not only the real-time diagnosis of said faults, but also continuous learning through refined algorithms. This is the case of Chinese patent CN108241348, which stands out due to the proposition of an algorithm database that is constantly sieved by evaluation indicators aimed at identification of an ideal algorithm and, thus, the attainment of an overall fault monitoring and detection method.

The importance of monitoring control parameters (and not only observable parameters) has been previously seen, in order to enable automatic intervention of smart process control systems through sensing mechanisms provided by IoT technologies. In this sense, patent CN105699345 stands out, which uses calibration curves to adjust fluorescence measurements in algorithms aimed at measuring pollutant levels in water bodies and soils. Our recent development of a hybrid industrial contaminant control system is also highlighted here, applicable to the paper production sector and covered by patent BR1020200024329, which allows measuring the level of colloid contaminants featured in the “white water” of the process and also its hardness through indirect turbidity and conductivity measurements, much simpler than the error-prone and cumbersome methods.

Regarding the application of artificial intelligence in control of industrial processes, the pioneer work described in US20060172427 that uses an algorithm-based “virtual sensor” for dosage control of chemicals used in high-precision electroplating baths in the semiconductor industry shall be highlighted.

More recent works should also be mentioned in other industry sectors that had progress in machine learning techniques for control of industrial processes through learning and predictive algorithms, where CN102266927 stands out by releasing a robust algorithm for determining the amount of heat in steelwork melting and casting processes, as well as a non-linear molding system proposed in CN103500281, which brings significant performance increases in sugar crystallization and evaporation process.

Learning and predictive algorithms in the paper production sector came about in 2016 with the pioneer work (US20160378073) of company Honeywell Limited, which enabled the development of an “objective function” that takes into account the properties that affect process output, the quality of paper produced and cost functions, using sensors that “trigger” when faults are identified, allowing to run predictive models for the ideal manufacturing system.

The work that is more similar to a specific application of chemicals in paper plants, more particularly in tissue paper, was recently released in US20190024316 and focuses on a simple algorithm that measures the natural coating potential of Yankee rolls through online measurements of certain characteristics of the cellulose pulp, its flow and machine speed to trigger the optimized dosage values of coating and release products on the surface of the roll for automatic adjustment of the sheet crepe.

Another specific application in the paper production sector, of particular interest to the scope of this Invention Patent, comprises the treatment of clothing and other paper and cellulose production machines which is key to maintaining productivity levels, production costs and quality of produced paper in the sector industries, particularly in face of the current water circuit closure levels with increasing organic and inorganic contaminant contents, leading to occurrence of larger deposits, which affect drainability and, as a consequence, the life span of felts and screens.

Among the approaches found in patent literature, the first patent PI 9715083-5, which was amended in PI 0503029-3 and internationally extended in WO 2008/012597. This continuous chemical treatment system of clothing and machine parts is distinguished by the combination of a thermal injector pump type thermodynamic equipment or heat exchanger that combines water, steam, and chemicals to produce an “active solution” with a high cleaning power of said contaminants.

### ISSUES WITH THE STATE OF THE ART

Technical limitations of the works that based the current survey have not only approached the specific process control systems for treatment of clothing and parts of paper and cellulose production machines, but, likewise, the advancements in the application of techniques that corroborate with the completion of systems that apply artificial intelligence in different industrial segments. Clearly, processes that used the first machine learning algorithms in the paper production sector shall be emphasized.

At first, the works from the University of Science & Technology of Beijing were considered, featured in Chinese Patent CN108241348, which, in spite of highlighting the importance of real time fault monitoring and guidance for data collection and use of evaluation indicators through learning and predictive algorithms, have superficially approached the logic of mathematical models behind said algorithms and did not mention any actual applications in industrial processes, thus limiting a more practical view of the method.

On the other hand, patent CN105699345, despite illustrating the use of calibration curves to estimate pollutant levels through fluorescence spectroscopy, this is not an applicable technique to the paper production sector, where contaminants (pitch and stickies) are varied and many do not have any significant fluorescence emission. Our patent BR1020200024329 has allowed advances in monitoring of said specific contaminants in paper and cellulose production processes, although many control parameters still required on-site or off-site analyses, such as the turbidity differential with pH adjustment to stimulate the contaminant levels. Conductivity, on the other hand, may be measured online and used to imply the white water hardness level.

On patents US20060172427, CN102266927 and CN103500281, mentioned in the state of the art as examples of application of artificial intelligence and machine learning algorithms in process controls of different industrial sectors, despite richly describing the mathematical functions that permeate the learning and predictive algorithms, in addition to various sensing mechanisms (IoT) to enable automatic dosage changes of chemicals, a system that enabled easy transposition to a contaminant control scenario in the paper production sector was not found.

In this sector, we saw that the pioneer work of Honeywell Limited published in US20160378073 has represented advances for optimization of the overall paper manufacturing process, however, this is a very comprehensive learning algorithm and does not deal with the particular aspects of each of the involved secondary processes. Conversely, patent US20190024316 was too specific in proposing its system and method for regulating the application of coating chemicals on Yankee rolls based on a predictive algorithm for the natural coating potential of the materials included in the composition of the cellulose pulp. Clearly the potential of artificial intelligence was shown therein, allowing for fine tuning of the chemical dosage, thus preventing waste and susceptibility to human error. However, the algorithm is specific and is not applied otherwise in the wet parts of the paper and cellulose production machines.

Among specific paper production applications, of particular interest in this context, our original patent PI9715083-5 for continuous chemical treatment of clothing which, in spite of advancements attained in PI0503029-3 and WO2008/012597, with highlights to possible “individual” treatment, still lacked suitability to new IoT technologies for real time monitoring of relevant control parameters, as well as minimizing human intervention through artificial intelligence methods in decision making regarding mechanical parameters such as application temperature and pressure, and the best application strategy for chemicals, more particularly continuous and shock dosage levels, in addition to periodicity and duration.

Clearly this is a challenge from the viewpoint of process automation and control, however, machine learning methods have helped discover process input and output data, finding causal relationships through learning and predictive algorithms that, lastly, help in the mathematical modeling capable of carrying out very assertive predictions on system performance.

Based on the issues exposed herein, in face of the breadth of research of the patents featured herein, other processes directly or indirectly related to the specific object of this Invention Patent were not found in the INPI archives, nor in other patent offices worldwide.

### OBJECTIVE OF THE INVENTION

One of the main objectives of this invention Patent application is the implementation of a process control system equipped with artificial intelligence, which is specifically aimed at the paper and cellulose machine clothing and parts.

Another objective of this invention Patent application is to implement a smart process control system for continuous treatment of clothing, in which three methods of machine learning are comprised that use specially developed learning and predictive algorithms.

### BRIEF DESCRIPTION OF THE INVENTION

This Invention Patent application implements a smart process control system for treatment of paper and cellulose parts and clothing, in order to enable automatic decision making on the best chemical and mechanical strategy for application in search of the best performance, that is only possible through machine learning methods as per evidenced by the benefits listed below:

Automatic definition of startup conditions of a new treatment system, extrapolating mechanical and chemical parameters through queries to the knowledge base, preventing human error in the project;

Online monitoring of more relevant process parameters for detection of faults and opportunities in machine productivity and/or quality of paper produced;

Learning algorithms capable of analyzing historical data of optimized operation conditions in our knowledge base, tracing dynamic causal correlations among the main process parameters;

Provides the automatic mode with dosage adjustments for continuous application of chemical products, as well as ensuring the best strategy for preventive shocks, with proper changes in periodicity and duration;

Enables safe and gradual reduction of the consumption of cleaning chemicals and clothing conditioners, decreasing application costs, and minimizing environmental risks;

Predictive algorithms that continuously pursue the ideal conditions through conditional probabilities that explore the application limits, respecting other system restrictions and the machine itself.

### BRIEF DESCRIPTION OF THE FIGURES

This invention Patent application shall be described, in detail, with reference to the drawings listed below, in which:

FIG. 1 shows a diagram of the smart process control system 100 for continuous treatment of paper and cellulose machine clothing and parts, based on three supplementary methods (101, 102 and 103) that use machine learning techniques;

FIG. 2 represents a binary tree, four-level type similarity algorithm for typical production process of package paper, for example;

FIG. 3 shows a chart with an example for the chemical strategy for continuous application of an alkaline cleaning product, followed by preventive periodic shocks of an acid cleaning agent every 24 hours;

FIG. 4 shows the process involved in the similarity algorithm that uses Correlation Maps (MC|Mapas de Correlação) and Similarity Profiles (PS|Perfis de Similaridade) to find the optimized operation condition;

FIG. 5 shows the resolution conditions of characteristic situations according to the standard Gaussian distribution both for mechanical (Φ_{mec}) and chemical (Φ_{quim}) parameters;

FIG. 6 allows observation of a diagram illustrating the main components of the computer system 200 required for implementation of this invention;

FIG. 7 illustrates a “fault” diagram related to the second evaluation circumstance of the knowledge base related to the method (102) of monitoring of relevant parameters, which, in turn, is portrayed in FIG. 1; and

FIG. 8 illustrates an opportunity diagram related to the driven statistical simulation method 103.

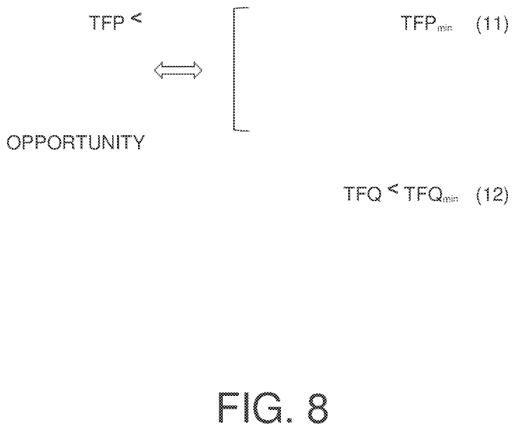

### DETAILED DESCRIPTION OF THE INVENTION

The core of this invention Patent application is the smart control system for continuous treatment of clothing, wherein it uses machine learning for enabling automatic decision making on the best chemical and mechanical strategy for application, such as the most suitable temperature and pressure on showers or even selection of the best chemicals for both ongoing and shock applications, their respective dosages, frequency and duration of preventive shock treatments.

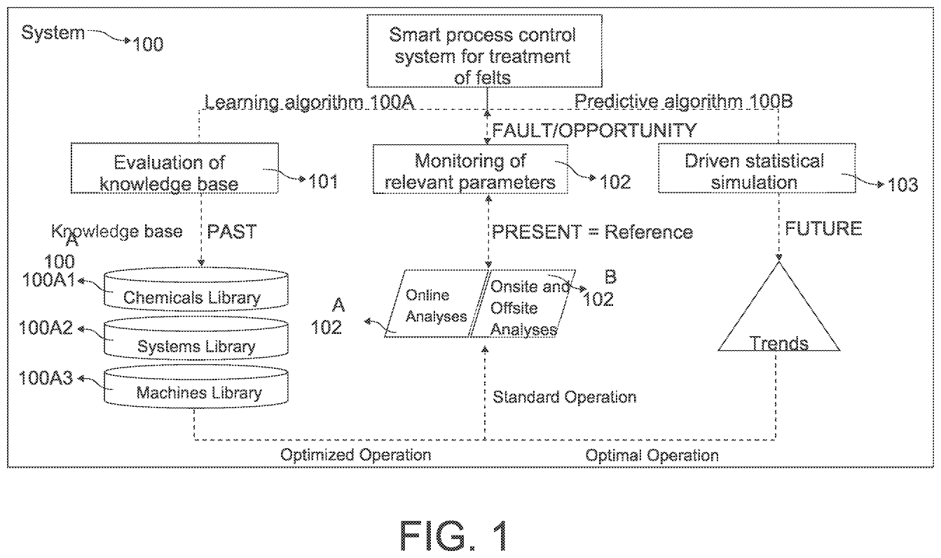

As shown in FIG. 1, said smart process control system 100 is based on three complementary methods that use machine learning techniques, namely:

1. Method 101 of assessment of knowledge base;
2. Method 102 of monitoring of relevant parameters;
3. Method 103 of driven statistical simulation.

Summarily, the method 101 is capable of looking into historical data in our knowledge base 101A, comprised of information already collected in dozens of treatment systems installed in paper and cellulose machines spread around the world, divided into chemical libraries 101A1, system libraries 101A2 and machine libraries 101A3, in order to reach the optimized operation condition which becomes the new standard operation condition for continuous treatment of clothing.

Afterwards, the monitoring method 102 of relevant control parameters for identification of faults or opportunities in this reference situation and the automatic “trigger” for learning or predictive algorithms to be detailed further below in this document. Depending on this control parameter, this monitoring may be carried out in real time, through continuous online analyses 102A with the generation of a massive data volume, as well as onsite or offsite periodic analyses 102B that require sampling techniques and generation of discrete data.

Lastly, the method 103 of driven statistical simulation makes use of conditional probabilities through predictive algorithms, allowing extrapolation of the known application limits (resolution conditions), identifying trends for the future and extrapolating possible incremental changes for certain control parameters, arriving at a new optimal operation condition that ends up being the “new standard” for treatment of clothing, provided certain system and machine restrictions are respected.

Below, more important aspects of each of these three machine learning methods that comprise this technological solution and may be activated at any moment in the artificial intelligence cycle proposed herein will be detailed.

### Evaluation of Knowledge Base:

The knowledge base evaluation method (101) involves queries to the three aforementioned chemical libraries (101A1), system libraries (101A2) and machine libraries (101A3), in order to “mine” data to attain a certain system for clothing treatment that is more similar to the reference system conditions, always taking into account both circumstances comprising the distinct negotiations and purposes: at the startup for establishing the parameterization for system start or operation optimization routine.

In both cases, it is understood that the use of the learning algorithm (100A) is the best way to quantitatively evaluate the degree of similarity between the reference system and the “universe” of many systems already in operation in other factories and compiled in our knowledge base, in order to find the more relevant variables both for startup and for the operation routine.

This Invention Patent outlines the algorithms developed for each circumstance, although all use the aforementioned parameters, to varying degrees, particularly those that may influence in the deposition potential of contaminants in the wet part of machines and, therefore, in the cleaning efficiency of clothing treatment systems.

Afterwards, Table 1 includes a list of the main parameters considered relevant in each category, however, it must not be considered restrictive, given other parameters may be included by the people skilled in the art.

Chart 1

| | |
|---|---|
| INTERNAL | EXTERNAL |

CONTROL PARAMETERS

| | |
|---|---|
| Continuous application product dosage | Rated machine speed |
| Shock application product dosage | Suction boxes vacuum level |
| Shock application period | Felt weight |
| Shock application Duration | Felt water content (porosity) |
| Number of fan jet showers | Felt Lifespan (days in production) |
| Number of needle jet showers | Air permeability to the stretching roll |
| Number of fan jet shower nozzles | Dryer vapor pressure |
| Distance between nozzles | White water turbidity |
| Rated shower flow | Contaminant count in white water |
| Application pressure | White water hardness |
| Application temperature | White water conductivity |

OBSERVABLE PARAMETERS

Wood type (eucalyptus or pine), type and weight of paper produced, production
receipt, type of trim (recycled fiber), use of scrap, type of pulping (chemical
or mechanical), cleansing system, type, and width of the machine

Algorithms were developed for addressing the specific objectives listed herein and blend various techniques, highlighting a first triage involving binary tree algorithms, as well as mathematical modeling based on the empirical knowledge of the specific industrial process and variants of genetic algorithms especially adapted to reach more accurate correlations between evaluated systems.

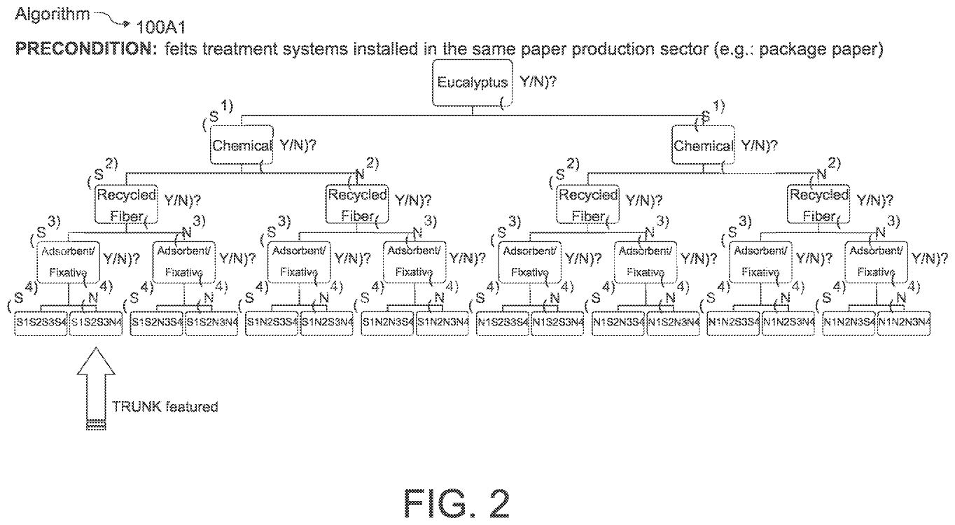

Firstly, the binary tree algorithm 100A1 is clarified herein, portrayed in FIG. 2, which applies both to the mentioned circumstances, both in startup and in optimizing operations. This specific algorithm aims at identifying, in the libraries of the knowledge base, the “family” of treatment systems with characteristics that are more similar to the reference system which may in fact be comparable. Therefore, part of the precondition of always analyzing treatment systems of machine clothing of the same paper segment: cellulose, print and writing paper, tissue, packaging, or special papers. Therefore, initially only “binary qualitative variables” are considered, which are those with assertive Yes/No (Y/N) questions that are relevant for the control of pitch and sticky deposits, distributed in different decision levels.

In this sense, aspects on the wood origin (eucalyptus or pine), the type of pulping process (chemical or mechanical), paper recipe (whether recycled fiber/scrap is used) and the pulp treatment strategy (whether adsorbent/fixative is included) are among the variables that may be considered on the first levels of the decision tree. The flowchart featured in FIG. 2 shows a four-level binary tree for a typical package paper production process, attesting the use of eucalyptus cellulose on the first level (S1) and the chemical pulping process on the second level (S2), also aggregating recycled fiber on the third level (S3), but not including an adsorbent/fixative in mass treatment on the fourth and last level (N4). Therefore, the clothing treatment systems within the same trunk must always be compared, at least on the third and fourth level, in this case specifically in (S1S2S3) or (S1S2S3N4), respectively.

In order to determine the startup treatment system starting condition, a learning algorithm must be used that reflects the contribution of the main aforementioned parameters. Therefore, an empirical “objective function” was outlined based on process knowledge that correlates cleaning efficiency (ε) with mechanical (Φ_{mec}) and chemical (Φ_{quim}) parameters of the application system, and also the potential for deposition of contaminants (δ) in the machine and in the approach circuit, as per the equation (1): Despite the value being dimensionless, the cleaning efficiency (ε) may be expressed mathematically through an index (varying from 0 to 1) proceeding with the “normalization” technique of compiled amounts at the knowledge base.

$$= \frac{{Φ}_{mec} \cdot {Φ}_{quim}}{δ} \qquad ( 1 )$$

With prior knowledge of the process deposition potential severity (δ=high, average or medium), the machine library must also be queried (101A3), filtering only systems belonging to the same trunk up to the third level (see FIG. 2) through the binary tree algorithm (100A1) and with the same deposition potential (ex. δ=high). Afterwards, the result is presented in an ordered rank by cleaning efficiency (ε) and the TOP 1 system would be chosen to be extrapolated the same mechanical (Φ_{mec}) and chemical (Φ_{quim}) for the reference system. The equations involved are to be detailed afterwards, however, the “objective function” should not be limited, and may evolve upon experimentation of the learning algorithms provided, so that variation proposals by people skilled in the art are perfectly admissible, and even expected, within the scope presented herein.

As described in equation 2 below, mechanical parameters (Φ_{mec}) of the reference system that enhance clothing cleaning and conditioning may be expressed by application pressure and temperature (Pₐₚₗ and Tₐₚₗ), in addition to a certain number of fan type (N°_{leque}) and needle type (N°_{agulha}) nozzle showers. In order to complete the estimate, the Wear Rate (TD %) of the most affected items by use time must also be considered, which would be fan type shower nozzles and the “internal” parts of the system that comprise a series of small parts and seals described in our patent PI0503029-3.

$$\begin{matrix} {Φ}_{mec} = \frac{{P}_{apl} \cdot {T}_{apl} \cdot ( {{N}^{o}}_{leque} + {{N}^{o}}_{agulha} )}{( {e}^{TDint} + {e}^{TDbicos} )} & ( 2 ) \\ where , \\ {TD}_{int} = internal part wear rate \\ {TD}_{int} = nozzle wear rate & \\ {TD}_{internos} = 1 - ( \frac{Tempo {vida}_{internos}}{90 dias} ) \cdot 100 & ( 2 A ) \\ {TD}_{bicos} = 1 - ( \frac{Tempo {vida}_{bicos}}{360 dias} ) \cdot 100 & ( 2 B ) \\ ( 2 A ) internal part service life - 90 days ; \\ ( 2 B ) nozzles service life - 360 days . & \end{matrix}$$

In turn, chemical parameters (Φ_{quim}) are obtained by equation 3 and reflect the contribution in cleaning efficiency of clothing by chemical products dosed in different concentrations during continuous application (C_{cont}) and shock application (C_{choq}), always considering, in this case, the duration of the preventive shock (t_{choq}) and the spacing between them (γ_{choq}).

$${Φ}_{quim} = [ {C}_{cont} + \sqrt{( \frac{{C}_{choq} \cdot {t}_{choq}}{{γ}_{choq}} )} ] \qquad ( 3 )$$

Specifically on chemicals, the queries to the knowledge base must involve a query to the chemicals library (101A1) only for systems of the same paper segment in the third and fourth level trunks, filtered through the binary tree algorithm (100A), providing options to the TOP 5 systems of the rank obtained, although the definition is pending final laboratory confirmation for the best alternative for continuous or shock application through cleaning efficiency analyses, using real felt samples extracted from said paper or cellulose production machine.

Regarding the chemical shock treatment, two strategies are provided: one “preventive” strategy that takes place in defined periods of time (e.g.: every day) and another emergency “corrective” strategy, which is triggered by operators only when the contaminant level reaches the limit, under risk of tearing the paper sheet or even the felt. Thus, the importance is of automatic modulation of said preventive shocks is evidenced, according to the dosage profile (concentration) versus time, alternating with the period (γ_{choq}) and time (t_{choq}) according to the severity of the deposition potential and respecting the daily consumption restriction of the chemical established by the client. The adoption of a proper strategy of preventive shocks is key to avoid emergency situations.

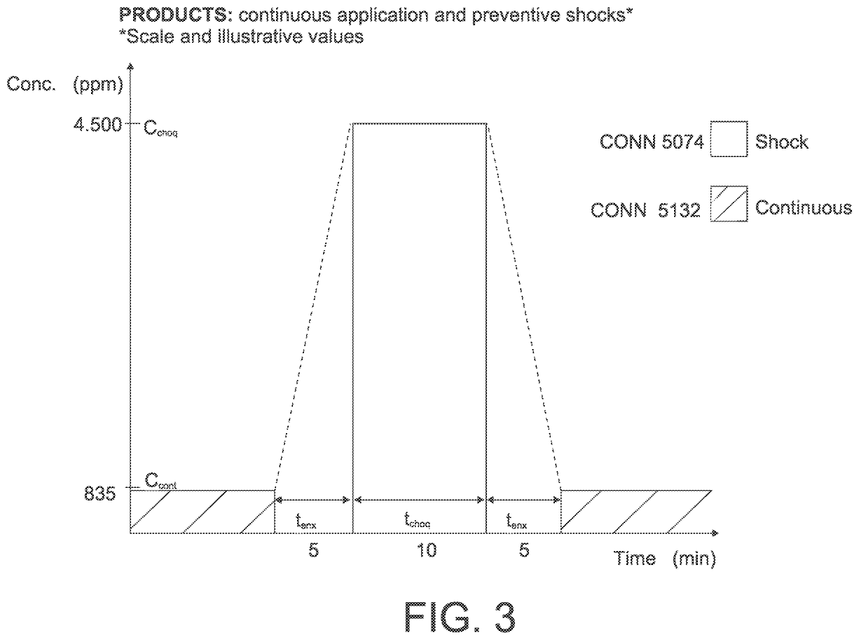

The chart featured in FIG. 3 shows an example of continuous application of an alkaline cleaning product (e.g.: CONN 5132) at a 835 ppm standard concentration (C_{cont}), followed by preventive periodic shocks every 24 h of an acid cleaner (e.g. CONN 5074) with a 4,500 ppm standard concentration (C_{choq}) and duration of 10 min (t_{choq}), always with at least 5 minutes of rinsing before and after the shock (tₑₙₓ). Both the period (γ_{choq}) and the time (t_{choq}) of preventive shocks are modulated automatically according to the severity of the deposition potential (δ). It should be observed that, for every paper segment, a distinct chemical strategy is used, so that application variations are evident to the people skilled in the art and are comprised in the scope of this invention Patent.

In addition, the rationale of the deposition potential estimation on clothing (δ) described in equation 4, which must be mainly related to the amount of contaminants in the machine and in the machine circuit (Q), and may also be incremented by paper weight (η) and the life span of the felts (T_{felt}) which reflects the uninterrupted production time. On the other hand, production parameters are weighed, such as rated machine speed (V_{maq}), vacuum level in suction boxes (λ) and water level on felts (%_{H2O}) which reflects porosity or, more particularly, its draining ability. Lastly, the amount of contaminants (Q) follows the specific function described by equation 5, considering the sum of the most relevant microscopic counting analyses of colloid contaminants in different points of the process (ANAL_{cont}), white water hardness (ANAL_{dur}), the degree of closure of the water circuit (%_{circ}), weighed by the amount of virgin fiber in the paper recipe (%_{fibra}).

$$\begin{matrix} δ = \frac{{Q}^{2} \cdot η \cdot {T}_{felt}}{{V}_{maq} \cdot λ \cdot {e}^{H 2 O}} & ( 4 ) \\ Q = \frac{( \sum {ANAL}_{cont} + {ANAL}_{dur} ) \cdot {e}^{circ}}{{e}^{fibra}} & ( 5 ) \\ Where : \\ Q = amount of contaminants \\ η = Paper weight \\ {T}_{felt} = Average lifespan of felts \\ {V}_{maq} = Rated machine speed \\ λ = Suction boxes vacuum level \\ {\%}_{H2O} = Felt water contents \\ {ANAL}_{cont} = Contaminant count \\ {ANAL}_{dur} = White water hardness \\ {\%}_{circ} = degree of closure of the water circuit \\ {\%}_{fibra} = Virgin fiber contents & \end{matrix}$$

### Monitoring of Relevant Parameters:

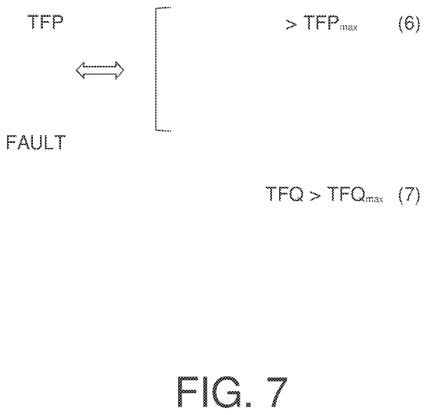

The second circumstance for evaluation of the knowledge base aims at optimizing the reference system operation routine through the monitoring method (102) of relevant parameters (FIG. 1). This optimization is only triggered when a “fault” is identified that affects machine productivity or the quality of paper produced. In other words, said faults are triggered when a certain “maximum limit” is reached for the Productivity Fault Rates (TFPₘₐₓ) or the Quality Fault Rates (TFQₘₐₓ), as per the restrictions approached in the diagram of FIG. 7.

In this specific case, TFP (%) is given by the number of hours that the machine produced below control speed (V_{cont}) whichever is considered a normal productivity level, according to client standards regarding the total amount of hours with the machine in operation. Equivalently, TFQ (%) is given by the number of paper tons produced with quality issues (Q) above the tolerable level for approval within specifications (Qₐₚᵣₒᵥ) weighing the total amount of paper produced (in tons) in the period considered. Below are equations 8 and 9 which describe said calculations.

$$\begin{matrix}TFP ( \% ) = \frac{{N}^{o} {horas}_{máq} ( V < {V}_{cont} )}{{N}^{o} total {horas}_{rodando}} & ( 8 ) \\ TFQ ( \% ) = \frac{{N}^{o} {ton}_{papel} ( Q > {Q}_{aprov} )}{{N}^{o} total {papel}_{produzido}} & ( 9 ) \\ ( 8 ) No hours - Total No of hours in operations ; \\ ( 9 ) No ton - Total No of paper produced . & \end{matrix}$$

Clearly a more comprehensive sensing model, provided by IoT technologies based on said integrated intelligence algorithms, would allow for extrapolation of equations that are equivalent to the aforementioned ones for triggering faults related to other relevant monitored parameters through online analysis or even periodic onsite or offsite measurements. An illustrative example would be the vacuum level at suction boxes which, when entering a zone considered “dangerous” from an operational point of view, would trigger a fault that activates the learning algorithm (100A), finding a new optimized condition in the knowledge base that would restore vacuum levels to standard amounts, thus preventing the paper sheet from tearing or, at its limit, the tear of the clothing itself.

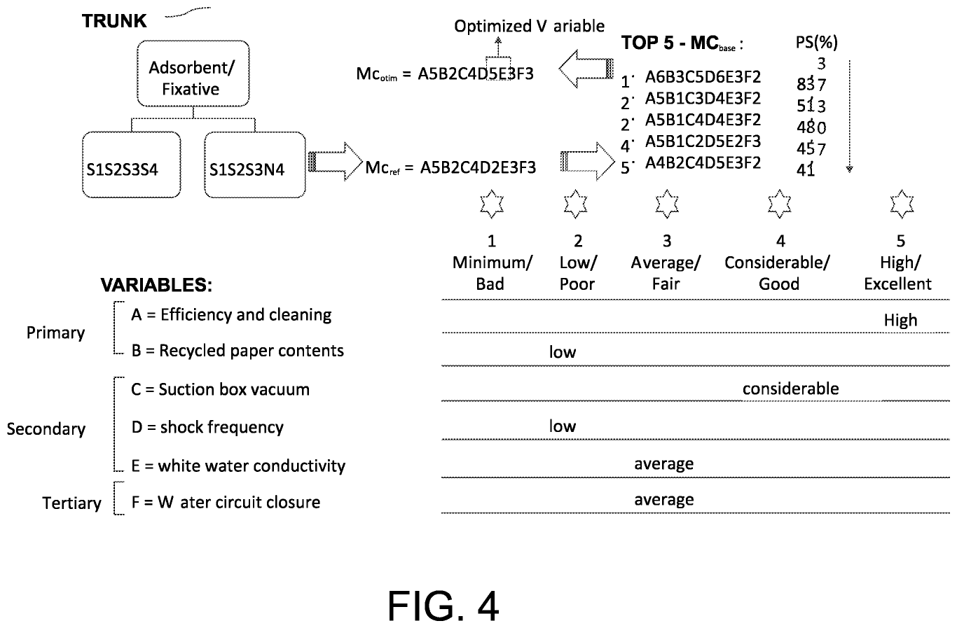

After a fault is identified, the same aforementioned binary tree algorithm (100A1) is run to identify the knowledge base systems (101A) with similar characteristics to the reference system, generating a Correlation Map (MC), which is a type of “genetic code” that describes unique characteristics of each. In this sense, the Correlation Map of the Reference System (MC_{ref}) is generated and compared to the Correlation Map of systems compiled from the knowledge base (MC_{base}) located on the same binary tree trunk (100A1), as shown in FIG. 4 for the example previously shown (trunk S1S2S3N4).

Specifically for Correlation Maps, only “scalable qualitative variables” are considered, highlighting the most relevant control parameters and attaining correspondence for a simple evaluation of the start type (scale from 1 to 5 from worst to best value), with variables being divided into the following categories, according to potential impact to the clothing treatment system: primary variables (high impact), secondary variables (average impact) and tertiary variables (low impact).

The amount of variables is dependent on each case. In said example (FIG. 4), primary variables were considered as cleaning efficiency of the continuous product application (A) and the amount of recycled paper in the recipe (B). For secondary variables, the suction box vacuum level (C), the periodicity of preventive shocks (D) and the level of white water conductivity (E). The only tertiary variable considered was the degree of closure of the water circuit (F).

Lastly, the Similarity Profile (PS %) is calculated for each system of the knowledge base, generating a TOP 5 rank of said systems, in which the TOP 1 system is selected for identification of the most relevant variable that is different from MC_{ref}, in the respective Correlation Map, which must be changed to finally generate the Correlation Map of the optimized system (MCₒₜᵢₘ). If there is no different variable for the TOP 1 system, the same analysis takes place for the TOP 2 system, and so on, until at least one different variable is found for the optimized operation condition proposal.

For this scenario, it should be observed that only two variables have differed in the Correlation Map of the TOP 1 system from the knowledge base, which are a secondary variable (D=shock frequency) and the other tertiary variable (F=water circuit closure), so that MC_{base} was significantly similar to MCᵣₑf, with the Similarity Profile PS=83.3%, calculated following equation 10:

$$\begin{matrix} PS = [ ( \frac{0 , 7 \cdot {{N}^{o}}_{prim}}{{{N}^{o}}_{tot prim}} ) + ( \frac{0 , 2 \cdot {{N}^{o}}_{sec}}{{{N}^{o}}_{tot sec}} ) + ( \frac{0 , 1 \cdot {{N}^{o}}_{terc}}{{{N}^{o}}_{tot terc}} ) ] \times 100 & ( 10 ) \\ Where : \\ {{N}^{o}}_{prim} = Number of similar primary variables \\ {{N}^{o}}_{tot prim} = Total number of primary variables \\ {{N}^{o}}_{sec} = Number of similar secondary variables \\ {{N}^{o}}_{tot sec} = Total number of secondary variables \\ {{N}^{o}}_{terc} = Number of similar tertiary variables \\ {{N}^{o}}_{tot terc} = Total number of tertiary variables & \end{matrix}$$

### Driven Statistical Simulation:

Following on the concept proposed herein, for the driven statistical simulation method 103, the trigger for the predictive algorithm (100B) is not a “fault”, but an “opportunity”, indicated by inequations 11 and 12 that likewise stipulate a certain minimum limit for the Productivity Fault Rates (TFPₘᵢₙ) or for the Quality Fault Rates (TFQₘᵢₙ). In other words, in this case the machine must have reached a production level at a speed significantly higher than the control speed (V>>V_{cont}) or the number of tons of paper produced with quality issues is negligible (Q<<Qₐₚᵣₒᵥ).

Regardless of the case, fact is in this “opportunity” situation the reference system must be operating with a performance above the expected production average, opening up some leeway to explore the limits of parametrization ranges, therefore, increasing the importance of prediction of simulated operational conditions. The predictive algorithm (100B) must, therefore, be based in conditional probabilities given by the “resolution situations” of the statistical models in which certain values are stipulated against possible amounts for relevant control parameters.

In such situation, particularly the increase in system cleaning efficiency (ε) is sought, however a hypothetical situation must be considered, in this case, in which the deposition potential (δ) is constant for the same machine, so that only mechanical (Φ_{mec}) and/or chemical parameters (Φ_{quim}) of the system are eventually adjustable. In this sense, the technique of this predictive algorithm (100B) involves statistical simulations for prediction of “characteristic situations” of said system and automatically trace “directed” variations of a single variable at a time, always gradually adopting situation parameters with cleaning efficiency (ε) immediately above, to be the new optimal system's operation standard.

The first step is to apply equations 2 and 3 previously featured in order to reach the exact value of mechanical (Φ_{mec}) and chemical (Φ_{quim}) parameters of the reference system and interpolate them with the value ranges outlined by “resolution conditions” for the universe of combinations of treatment systems of the knowledge base. In order to determine the resolution conditions for said combinations, the expected variables for the five characteristic situations of each parameter must be simulated separately: low (−−), borderline (−), typical (+−), borderline (+) and high (++). The sequence features a chart (chart 1) which summarizes these possibilities.

CHART 1

| | | | | | | |
|---|---|---|---|---|---|---|
| | | low | borderline | typical | borderline | High |
| PARAMETER | REFERENCE | (−−) | (−) | (±) | (+) | (++) |

MECHANICAL PARAMETERS

| | | | | | | |
|---|---|---|---|---|---|---|
| Pap1 | 9 | 5 | 7 | 10 | 14 | 18 |
| Tap1 | 79 | 75 | 78 | 80 | 83 | 85 |
| On Fan | 3 | 2 | 3 | 4 | 5 | 6 |
| On Needle | — | 1 | 1 | — | 5 | 6 |
| Internal parts | 50 | 108 | 99 | 90 | 81 | 72 |
| Lifespan (days) | | | | | | |
| Nozzles Lifespan | 380 | 432 | 396 | 360 | 324 | 289 |
| Internal wear (%) | 44% | −20% | −10% | 0% | −10% | −20% |
| Nozzle wear (%) | −6% | −20% | −10% | 0% | −10% | −20% |

CHEMICAL PARAMETERS

| | | | | | | |
|---|---|---|---|---|---|---|
| Ccont (ppm) | 500 | 585 | 710 | 835 | 960 | 1,086 |
| Cchoq (ppm) | 6,000 | 3,150 | 3,825 | 4,500 | 5,175 | 5,850 |
| Tchoq (min) | 30 | 7.0 | 8.5 | 10.0 | 11.5 | 13.0 |
| Ychoq (days) | 7 | 4.0 | 4.8 | 5.7 | 6.6 | 7.4 |

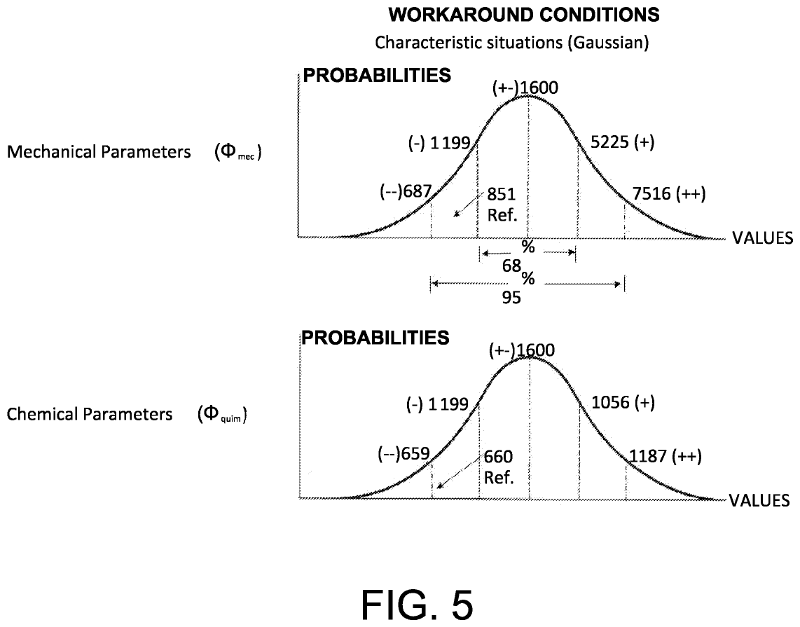

For the reference system, with respective parameters also shown above, the amount of 851 was determined for mechanical Parameters (Φ_{mec}) which frames it between the low (−−) and borderline (−) status, ranging from 687 and 1,199 (see FIG. 5 for classification in the standard Gaussian distribution curve). For chemical parameters (Φ_{quim}), on the other hand, the value was 660, typically classified as low (−−). Therefore, in a “driven simulation”<for this specific case, according to the predictive algorithm (100B) proposed herein, the continuous application concentration (C_{cont}) could have been automatically increased from 500 to 585 ppm which is the status threshold immediately above (low (−−)), thus observing the benefits expected over cleaning efficiency (ε). With no negative effects in application, this would be considered the new system operation condition.

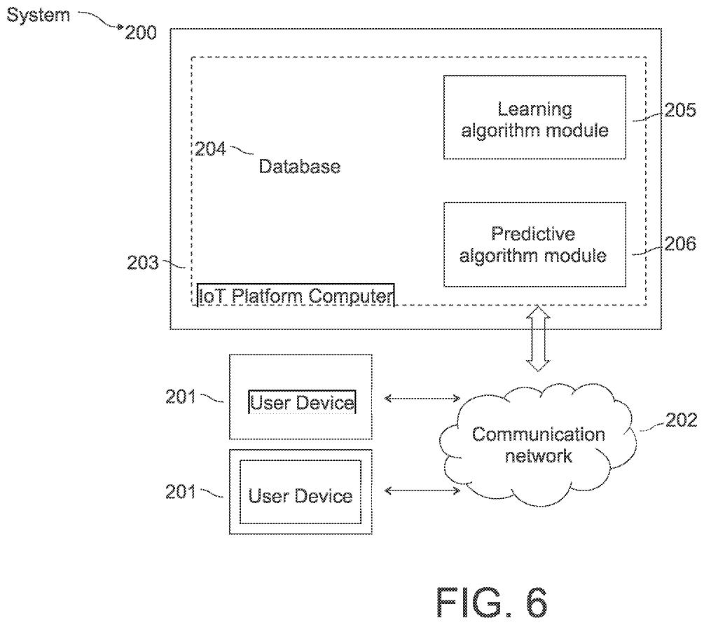

The foretold implementations in this Invention Patent are only possible if the smart process control system (100), in addition to the three supplementary methods (101), (102) and (103) are applied through a computer system (200) that basically comprises a module of the learning algorithm (205) and another module of the predictive algorithm (206), further comprised by the user devices (201), a communication network (202), an IoT platform computer (203) and a database (204), as per FIG. 6.

User devices (201), used to access the IoT platform, may be desktop-type personal computers and laptops, or any other mobile device, such as tablets and smartphones. The operations of said system are accessible via a communication network (202), (e.g.: Internet) or one or more suitable interfaces (e.g.: Application Program Interfaces—APIs). The user interacts with the tool through a web browser, or any other application installed in the device (201). The IoT platform computer (203) comprises a database (204), responsible for the communication and data loading to the user device (2010, though the communication network (202). It also comprises a computer program to run specific algorithms from modules (205) and (206), which may be written in any programming language (e.g.: PHP or Java).

Lastly, depending on the provided possibilities, some events, mathematical functions, or specific processes of any of the algorithms described herein may be changed, removed, used in distinct sequences, or blended with no harm to their main function logic. Therefore, in spite of particular implementations detailed herein, this Invention Patent application should not be considered as limited to said descriptions. Likewise, it should remain obvious to those skilled in the various arts involved that any changes, apparent or otherwise, may be incorporated as an integral part of this document and yet remain in agreement with the scope of the following claims.

1. “SMART PROCESS CONTROL SYSTEM FOR CONTINUOUS TREATMENT OF CLOTHING”, wherein it uses machine learning for enabling automatic decision making on the best chemical and mechanical strategy for application, such as the most suitable temperature and pressure on showers or even selection of the best chemicals for both ongoing and shock applications, their respective dosages, frequency and duration of preventive shock treatments.

2. “SMART PROCESS CONTROL SYSTEM FOR CONTINUOUS TREATMENT OF CLOTHING”, according to claim 1, wherein said system (100) is based on three supplementary methods, among which the method (101) for assessment of the knowledge base, the method (102) for assessment of relevant parameters and the method (103) of driven statistical simulation.

3. “SMART PROCESS CONTROL SYSTEM FOR CONTINUOUS TREATMENT OF CLOTHING”, according to claim 1, wherein the method for assessment of the knowledge base (101) considers knowledge-based queries (101A) with information collected from systems installed in cellulose and paper machines, divided into chemicals libraries (101A1), systems libraries (101A2) and machinery libraries (101A3), in order to “mine” data and find whether a certain clothing treatment system that is more similar to the reference system conditions.

4. “SMART PROCESS CONTROL SYSTEM FOR CONTINUOUS TREATMENT OF CLOTHING”, according to claim 3, wherein the knowledge-based queries (101A) are carried out through learning algorithms (100A) which allow establishing a more relevant parametrization both for startup and for the reference system operation routine.

5. “SMART PROCESS CONTROL SYSTEM FOR CONTINUOUS TREATMENT OF CLOTHING”, according to claim 3, wherein the learning algorithm (100A) comprises a binary tree algorithm (100A1) in order to identify the “family” of treatment systems in libraries 101A1, 101A2 and 101A3 with aspects that are more similar to the reference system and may indeed be comparable, based on the premise of always analyzing systems of the same paper segment, and only considering the relevant “binary qualitative variables”.

6. “SMART PROCESS CONTROL SYSTEM FOR CONTINUOUS TREATMENT OF CLOTHING”, according to claim 5, wherein the “binary qualitative variables” are obtained at the different levels of the decision tree through assertive questions such as Yes/No (Y/N) questions on the origin of the wood (eucalyptus or pine), the type of pulping process (chemical or mechanic), the paper recipe (if recycled fiber/scrap) and the pulp treatment strategy (whether adsorbent/fixative), always comparing the treatment systems found within the same “trunk”, at least at the third or fourth level.

7. “SMART PROCESS CONTROL SYSTEM FOR CONTINUOUS TREATMENT OF CLOTHING”, according to claim 3, wherein the learning algorithm (100A) also comprises an empirical “objective function” based on process knowledge that correlates cleaning efficiency (ε) with mechanical (Φ_{mec}) and chemical (Φ_{quim}) parameters of the application system, and also the potential for deposition of contaminants (δ) in the machine and in the approach circuit, as per the equation (1):
$$= \frac{{Φ}_{mec} \cdot {Φ}_{quim}}{δ}$$

8. “SMART PROCESS CONTROL SYSTEM FOR CONTINUOUS TREATMENT OF CLOTHING”, according to claim 7, wherein the “objective function” (1) features dimensionless values for cleaning efficiency (ε), which may be mathematically expressed through an index (varying between 0 and 1), proceeding with the “normalization” technique of knowledge-based compiled values.

9. “SMART PROCESS CONTROL SYSTEM FOR CONTINUOUS TREATMENT OF CLOTHING”, according to claim 7, wherein mechanical system parameters (Φ_{mec}) optimize clothing cleaning, expressed by application pressure and temperature (Pₐₚₗ and Tₐₚₗ), a certain number of showers with fan jet nozzles (N°_{leque}) and needle jet nozzles (N°_{agulha}) in addition to wear and tear of shower nozzles (TD_{bicos}) and “internal” parts (TDᵢₙₜ) of the system, as per equation (2):
$${Φ}_{mec} = \frac{{P}_{apl} \cdot {T}_{apl} \cdot ( {{N}^{o}}_{leque} + {{N}^{o}}_{agulha} )}{( {e}^{TDint} + {e}^{TDbicos} )}$$

10. “SMART PROCESS CONTROL SYSTEM FOR CONTINUOUS TREATMENT OF CLOTHING”, according to claim 7, wherein the chemical parameters (Φ_{quim}) of the system reflect the contribution in cleaning by the chemicals dosed in different concentrations during ongoing (C_{cont}) and shock applications (C_{choq}), reflecting over the duration of the preventive shock treatment (t_{choq}) and the spacing period between them (γ_{choq}), according to equation (3):
$${Φ}_{quim} = [ {C}_{cont} + \sqrt{( \frac{{C}_{choq} \cdot {t}_{choq}}{{γ}_{choq}} )} ]$$

11. “SMART PROCESS CONTROL SYSTEM FOR CONTINUOUS TREATMENT OF CLOTHING”, according to claim 7, wherein it needs previous knowledge of the severity for deposition potential (δ) which must be categorized as high, average or medium, according to the amount of contaminants present in the machine and in the machine circuit (Q), to be incremented by the paper sheet weight (η) and felt life span (T_{felt}), in addition to pondering other production parameters such as rated machine speed (V_{maq}), vacuum level in suction boxes (λ) and the water level on felts (%_{H2O}), as described by equation (4):
$$δ = \frac{{Q}^{2} \cdot η \cdot {T}_{felt}}{{V}_{maq} \cdot λ \cdot {e}^{H 2 O}}$$

12. “SMART PROCESS CONTROL SYSTEM FOR CONTINUOUS TREATMENT OF CLOTHING”, according to claim 11, wherein the amount of contaminants (Q) takes into account the sum of the most relevant microscopic counting analyses of colloid contaminants in different points of the process (ANAL_{cont}), white water hardness (ANAL_{dur}), the degree of closure of the water circuit (%_{circ}) weighed by the amount of virgin fiber in the paper recipe (%_{fibra}) as per the specific function (δ):
$$Q = \frac{( \sum {ANAL}_{cont} + {ANAL}_{dur} ) \cdot {e}^{circ}}{{e}^{fibra}}$$

13. “SMART PROCESS CONTROL SYSTEM FOR CONTINUOUS TREATMENT OF CLOTHING”, according to claim 7, wherein it comprises the machinery library query (101A3), filtering through the binary tree algorithm only systems belonging to the same trunk up to the third level and with the same deposition potential, as well as featuring the result ranked by cleaning efficiency (ε) and the TOP 1 system would be chosen to have the same mechanical (Φ_{mec}) and chemical (Φ_{quim}) parameters extrapolated to the reference system.

14. “SMART PROCESS CONTROL SYSTEM FOR CONTINUOUS TREATMENT OF CLOTHING”, according to claim 7, wherein it comprises the chemicals library query (101A1), filtered by the binary tree algorithm (100A1) only for systems of the same paper segment to the third and fourth level “trunks” in order to bring about options to the TOP 5 ranked systems.

15. “SMART PROCESS CONTROL SYSTEM FOR CONTINUOUS TREATMENT OF CLOTHING”, according to claim 14, wherein it comprises the final laboratory confirmation of the best alternative for ongoing or shock application through cleaning efficiency analyses, using actual samples of felts extracted from said paper or cellulose machine.

16. “SMART PROCESS CONTROL SYSTEM FOR CONTINUOUS TREATMENT OF CLOTHING”, according to claim 10, wherein the chemical shock treatment provides a “preventive” strategy that takes place in determined time periods, and another “corrective” which is emergency, activated by the operators only when the level of contaminants reaches the limit.

17. “SMART PROCESS CONTROL SYSTEM FOR CONTINUOUS TREATMENT OF CLOTHING”, according to claim 16, wherein the preventive shocks are modulated automatically according to the dosage profile (concentration) versus time, respecting the daily chemical consumption restriction established by the client.

18. “SMART PROCESS CONTROL SYSTEM FOR CONTINUOUS TREATMENT OF CLOTHING”, according to claim 16, wherein preventive shocks follow spacing period that vary from hours up to days, and take place in concentrations (C_{choq}) of 1,000 to 10,000 ppm and duration (t_{choq}) from 5 to 30 minutes, always keeping one rinsing before and after the shock for, at least, 5 minutes (tₑₙₓ).

19. “SMART PROCESS CONTROL SYSTEM FOR CONTINUOUS TREATMENT OF CLOTHING”, according to claim 1, wherein the method (102) for monitoring the relevant parameters is activated only when a “fault” that affects machine productivity or the quality of the produced paper is identified, more specifically when a certain “maximum limit” is reached for Productivity Fault Rates (TFPₘₐₓ) or Quality Fault Rates (TFQₘₐₓ), as per restrictions (6) and (7).

20. “SMART PROCESS CONTROL SYSTEM FOR CONTINUOUS TREATMENT OF CLOTHING”, according to claim 19, wherein the Productivity Fault Rates (TFPₘₐₓ) is given by the amount of hours in which the machine has produced with speed (V) below the control speed (V_{cont}), regarding the total amount of hours with the machine in operation, as per equation (8):
$$TFP ( \% ) = \frac{{N}^{o} {horas}_{máq} ( V < {V}_{cont} )}{{N}^{o} total {horas}_{rodando}}$$

21. “SMART PROCESS CONTROL SYSTEM FOR CONTINUOUS TREATMENT OF CLOTHING”, according to claim 19, wherein the Quality Fault Rates (TFQₘₐₓ) is given by the amount of tons of paper produced with quality issues (Q) above the acceptable level for approval within specifications (Qₐₚᵣₒᵥ), weighing the total amount of paper produced within the period considered, as per equation (9):
$$TFQ ( \% ) = \frac{{N}^{o} {ton}_{papel} ( Q > {Q}_{aprov} )}{{N}^{o} total {papel}_{produzido}}$$

22. ““SMART PROCESS CONTROL SYSTEM FOR CONTINUOUS TREATMENT OF CLOTHING”, according to claim 19, wherein the method (102) provides the generation of a Correlation Map for the reference system (MC_{ref}) and its comparison with the Correlation Map of compiled systems at the knowledge base (MC_{base}) located on the same binary tree trunk (100A1).

23. “SMART PROCESS CONTROL SYSTEM FOR CONTINUOUS TREATMENT OF CLOTHING”, according to claim 22, wherein the Correlation Maps only employ “scalable qualitative variables”, highlighting the most relevant control parameters and making up the correspondence for a simple star-type evaluation, in which the variables are divided in the following categories according to the potential impact in the clothing treatment system: primary variables (high impact), secondary variables (average impact) and tertiary impact (low impact).

24. “SMART PROCESS CONTROL SYSTEM FOR CONTINUOUS TREATMENT OF CLOTHING”, according to claim 22, wherein it comprises the Similarity Profile calculation (PS %) of each system of the knowledge base, generating a TOP 5 ranking of said systems, in which the TOP 1 system is selected for identification of the most relevant variable that is different from MC_{ref}, which must be changed to finally generate the Correlation Map of the optimized system (MCₒₜᵢₘ), considering the amounts of similar variables in each category according to equation (10):
$$PS = [ ( \frac{0 , 7 \cdot {{N}^{o}}_{prim}}{{{N}^{o}}_{tot prim}} ) + ( \frac{0 , 2 \cdot {{N}^{o}}_{sec}}{{{N}^{o}}_{tot sec}} ) + ( \frac{0 , 1 \cdot {{N}^{o}}_{terc}}{{{N}^{o}}_{tot terc}} ) ] \times 100$$

25. “SMART PROCESS CONTROL SYSTEM FOR CONTINUOUS TREATMENT OF CLOTHING”, according to claim 24, wherein it provides that, if there is no different variable for the TOP 1 system, the same analysis takes place for the TOP 2 system, and so on, until at least one different variable is found for the optimized operation condition proposal.

26. “SMART PROCESS CONTROL SYSTEM FOR CONTINUOUS TREATMENT OF CLOTHING”, according to claim 1, wherein the driven statistical simulation method (102) is activated by an “opportunity” that takes place when reaching a certain minimum limit for the Productivity Fault Rates (TFPₘₐₓ) or Quality Fault Rates (TFQₘₐₓ), as per inequations (11) and (12).

27. “SMART PROCESS CONTROL SYSTEM FOR CONTINUOUS TREATMENT OF CLOTHING”, according to claim 26, wherein it uses the predictive algorithm (100B) based on conditional probabilities by “resolution situations” of statistical models in which certain possible values are stipulated for relevant control parameters, aimed at the increase of cleaning efficiency (ε) for a hypothetical situation in which the contaminant deposition potential (δ) is constant for the same machine, so that only mechanical (Φ_{mec}) and chemical (Φ_{quim}) parameters of the system are liable to eventual adjustments.

28. “SMART PROCESS CONTROL SYSTEM FOR CONTINUOUS TREATMENT OF CLOTHING”, according to claim 26, wherein the predictive algorithm (100B) involves statistical simulations for prediction of “characteristic situations” of said system and automatically trace “directed” variations of a single variable at a time, always gradually adopting situation parameters with cleaning performance immediately above to be the new optimal system's operation standard.

29. “SMART PROCESS CONTROL SYSTEM FOR CONTINUOUS TREATMENT OF CLOTHING”, according to claim 26, wherein it comprises the acquisition of the exact value of mechanical (Φ_{mec}) and chemical (Φ_{quim}) parameters of the reference system through equations (2) and (3) and interpolation of said value at the outlined value ranges for the universe of combinations of treatment systems of the knowledge base.

30. “SMART PROCESS CONTROL SYSTEM FOR CONTINUOUS TREATMENT OF CLOTHING”, according to claim 26, wherein it comprises the simulation prediction of expected variables of the five characteristic situations for each parameter, namely: low (−−), borderline (−), typical (+−), borderline (+) and high (++).

31. “SMART PROCESS CONTROL SYSTEM FOR CONTINUOUS TREATMENT OF CLOTHING”, according to claim 1, wherein the system (100), in addition to the three supplementary methods (101), (102) and (103), are dependent on a computer system (200) that basically comprises a module of the learning algorithm (205) and another module of the predictive algorithm (206), further comprised by the user devices (201), a communication network (202), an IoT platform computer (203) and a database (204).

32. “SMART PROCESS CONTROL SYSTEM FOR CONTINUOUS TREATMENT OF CLOTHING”, according to claim 31, wherein the user devices may be desktop-type personal computers and laptops or any other mobile device, such as tablets and smartphones, with operations accessible via a communication network (202) or one or more suitable interfaces, and users interact with the system (200) through a web browser, or any other application installed in the device (201).

33. “SMART PROCESS CONTROL SYSTEM FOR CONTINUOUS TREATMENT OF CLOTHING”, according to claim 31, wherein the IoT platform computer (203) comprises a database (204), responsible for data communication and loading for the user's device (201), through the communication network (202), also comprising a computer program to run the specific module algorithms for modules (205) and (206), which may be written in any programming language.
